(19) United States
(12) Patent Application Publication
(10) Pub. No.: US 2008/0196668 A1
(43) Pub. Date: Aug. 21, 2008

(54) Animal feeder assembly

(75) Inventor: Benjamin T. Clark, South Bend, IN (US)

Correspondence Address: R. Tracy Crump, P.O. Box 604, New Carlisle, IN, 46552, US

(73) Assignee: Farm Innovators, Inc.

(21) Appl. No.: 11/708,371

(22) Filed: Feb. 20, 2007

(51) Int. Cl. A01K 7/02; A01K 5/00

(52) U.S. Cl. 119/51.5

(57) ABSTRACT

The animal feeder combines a heated water basin with an automatic water level control valve and a separate feed basin in an elevated feeder housing. The diner includes a plastic housing, which has a flat top and a peripheral side wall. The diner housing is supported by four corner feet, which raises the top above the ground level. The housing top has two large depressions, which from a feed basin and a water basin. The diner can be connected to a water supply by a standard garden hose. A float valve mounted to the housing maintains the water level inside the basin. An electrical heating element mounted under the water basin prevents water from freezing when ambient temperatures drop below freezing.

This invention relates to an animal feeder assembly, and in particular, an animal feeder assembly, which includes an elevated feed basin and a heated water basin with an automatic water level control valve.

### BACKGROUND AND SUMMARY OF THE INVENTION

A variety of improvements have been incorporated into feed and water bowls for pets and small animals. Elevated animal feeders, which position the animal food above ground level, are well known for improving the posture and digestion of dogs. Heated water bowls have been developed to prevent water from freezing in cold environments. Other water bowls have control valves that automatically maintain the level of water in the bowl.

The animal feeder (“pet diner”) assembly embodying the present invention combines a heated water basin with an automatic water level control valve and a separate feed basin in an elevated feeder housing. The animal feeder assembly has a sturdy plastic housing, which includes a flat top and a peripheral side wall. The housing is supported by four corner feet, which raises the top above the ground level. The housing top has two large depressions, which form a feed basin and a water basin. The feeder assembly can be connected to a water supply by a standard garden hose. A float valve mounted to the housing maintains the water level inside the basin. An electrical heating element mounted under the water basin prevents water from freezing when ambient temperatures drop below freezing. The feeder assembly uses a detachable electrical cord, which can be removed during warm weather when the heating element is not needed.

The animal feeder assembly embodying this invention combines several useful features into a single convenient assembly. The heated water basin prevents water from freezing and the float valve ensures a constant supply of fresh water. A separate feed bowl can be seated within the feed basin or food stuffs can be directly deposited in the feed basin. The configuration of the housing elevates the feed and water basins above ground level, which has been proven to improve animal digestion and posture.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the animal feeder assembly of this invention;

FIG. 2 is a top view of the diner of FIG. 1;

FIG. 3 is a end view of the diner of FIG. 1;

FIG. 4 is a front view of the diner of FIG. 1;

FIG. 5 is a back view of the diner of FIG. 1; and

FIG. 6 is an exploded view of the diner of FIG. 1.

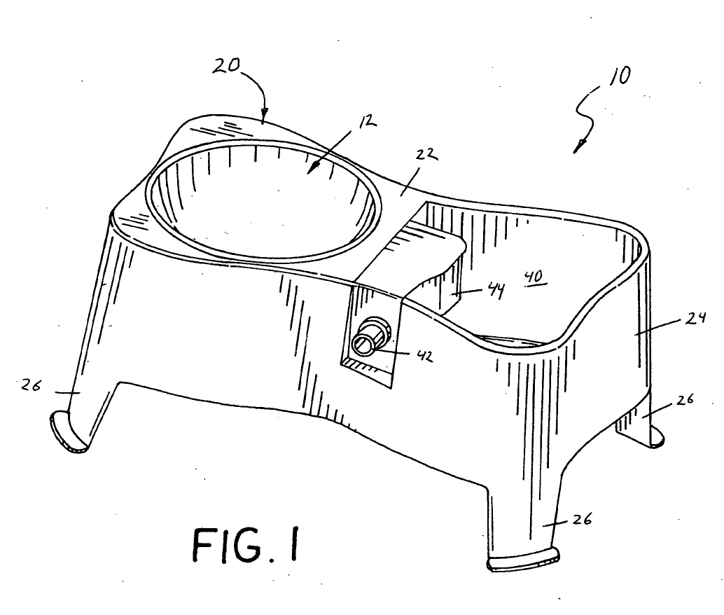

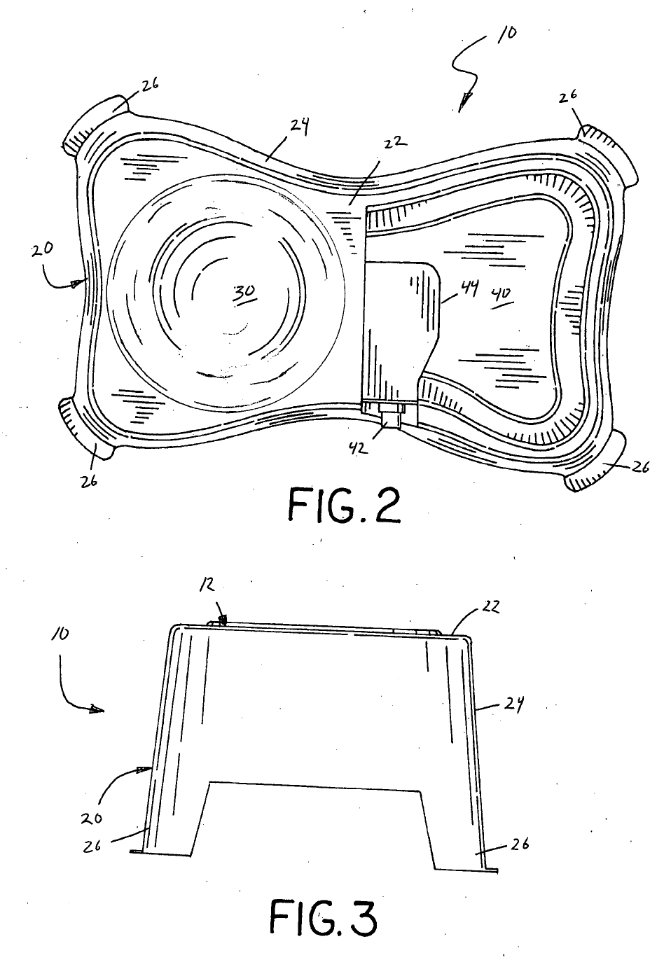

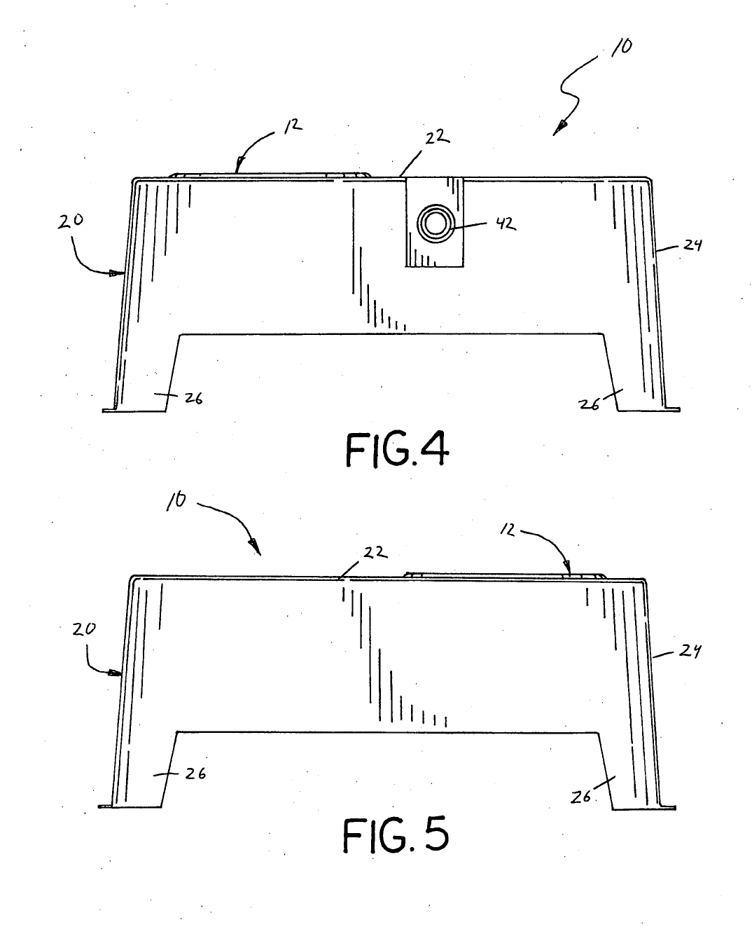

### DESCRIPTION OF THE PREFERRED EMBODIMENT

Referring now to the drawings, reference numeral 10 designates generally one embodiment of the animal feeder assembly (“pet diner”) of this invention. As shown, diner 10 is designed and intended for use by household pets, such as dogs and cats, but is particularly suited for large breed dogs. Feeder assembly 10 includes a molded reinforced plastic or formed fiberglass housing or body 20. As shown, housing 20 has a bow tie shaped configuration formed by a flat top 22 and sidewall 24 that extends downward from the periphery of the top 22. Housing 20 is supported above ground level by four feet 26, which extend integrally from the four corners of peripheral housing sidewall 24. As shown, the length of feet 26 and housing sidewall 24 are dimensioned to position top 22 at a suitable height above ground level for medium sized dogs to feed comfortably from the top of diner 10.

Housing top 22 has two large depressions, which form a feed basin 30 and a water basin 40. While food stuffs can be deposited directly into feed basin 30, a separate feed bowl 12 is seated within feed basin 30 to provide ease and convenience of cleaning. Generally, feed bowl 12 is constructed of stainless steel or plastic. Water basin 40 provides a space for water. A hose fitting 42 and a float valve 44 are mounted to housing 20. Hose fitting 42 extends through sidewall 24, which allows a standard garden hose (not shown) to connect feeder assembly 10 to a water supply. Float valve 44 sits inside water basin 40 and maintains the water level within the water basin. Float valve 44 is of conventional design and includes a float (not shown) operatively connected to the valve mechanism by a lever (not shown). When the water rises to the desired level within water basin 40, the float forces the lever to close the valve mechanism and shut off the water flow.

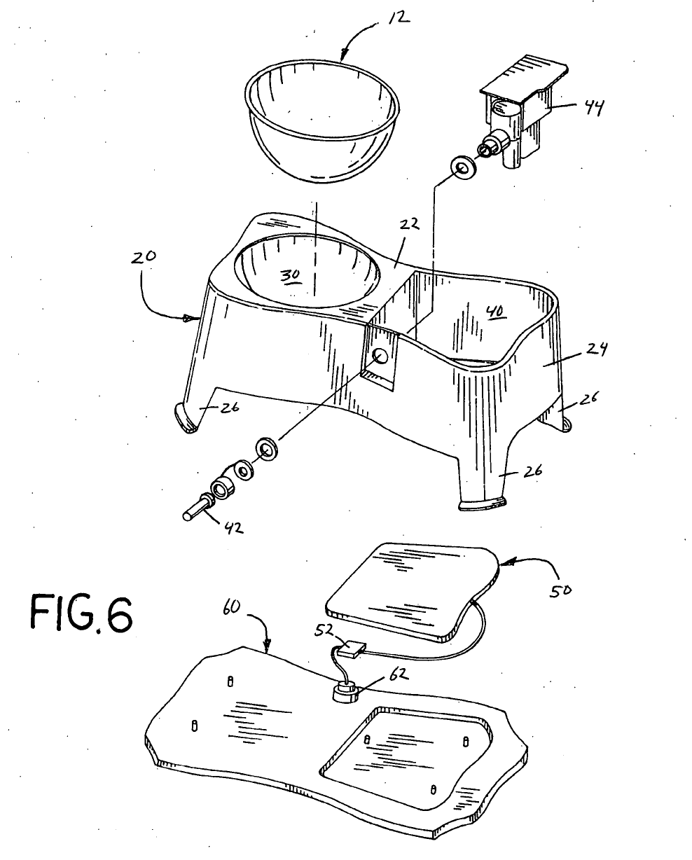

As shown in FIGS. 6 and 7, an electrical heating element 50 is mounted beneath the bottom water basin 40, which covers the area of the basin bottom. Heater element 50 is a foil type electric heater and includes a length of electrical resistance heating wire affixed to a backing of a thin sheet of pliable thermal conductive foil material. Heating element 50 emits thermal energy to heat water basin 40. Heating element 50 also includes a thermostat 52. Thermostat 52 uses a conventional snap action bimetal design, although other types of thermostats may be used within the teachings of this invention.

A cover plate 60 encloses the bottom of housing 20. Cover plate 60 is press fit between sidewalls 24. Cover plate 60 includes an electrical plug receptacle 62, which is electrically wired to heating element 50 and thermostat 52. A conventional electrical cord (not shown) is used to connect feeder assembly 10 to an AC electrical power source. Although, heating element 50 is preferably powered by an AC line power, the heating element can be modified for DC electrical power within the teachings of this invention.

One skilled in the art will note that the animal feeder assembly embodying this invention combines a heated water basin with an automatic water level control valve and a feed basin in an elevated housing. The configuration of the housing elevates the feed and water basins above ground level to improve the digestion and posture of the feeding animal. A separate feed bowl can be seated within the feed basin or food stuffs can be directly deposited in the feed basin. The feeder assembly is connected to a water supply by a standard garden hose and the float valve automatically fills the water basin to a selected level. The electrical heating element mounted under the water basin prevents water from freezing when ambient temperatures drop below freezing. The diner uses a detachable electrical cord, which can be removed during warm weather when the heating element is not needed. The electrical receptacle plug is located beneath the housing to prevent the animal from accidentally unplugging the cord. Locating the receptacle plug under the housing also provides a clean aesthetic appearance to the feeder assembly.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An animal feeder comprising:
a housing having a flat top and an integral sidewall extending peripherally around the top surface, the housing also includes a plurality of feet extending from the sidewall for supporting the housing and elevating the top surface above the ground, the top having a first recessed basin formed therein for receiving a food staple and a second recessed basin formed therein for receiving a volume of water;
a heating element mounted beneath the housing top under the second basin for emitting thermal energy to the housing top to heat the volume of water contained in the second basin; and
valve means mounted to the housing sidewall for maintaining the volume of water within the second basin.

2. The animal feeder of claim 1 wherein the heating element includes a thermostat for regulating the thermal energy from the heating element.

3. The animal feeder of claim 1 wherein the valve means includes a fitting mounted to the housing sidewall and adapted to connect the housing to a water supply.

4. The animal feeder of claim 1 and a bottom cover mounted to the housing between the peripheral sidewall and beneath the top to enclose the heating element.

5. An animal feeder comprising:
a housing having a flat top and an integral sidewall extending peripherally around the top surface, the housing also includes a plurality of feet extending from the sidewall for supporting the housing and elevating the top surface above the ground, the top having a first recessed basin formed therein for receiving a food staple and a second recessed basin formed therein for receiving a volume of water;
a heating element mounted beneath the housing top under the second basin for emitting thermal energy to the housing top to heat the volume of water contained in the second basin, the heating element includes a thermostat for regulating the thermal energy from the heating element;
a fitting mounted to the housing sidewall and adapted to connect the housing to a water supply;
valve means mounted to the housing sidewall in communication with the fitting for maintaining the volume of water within the second basin; and
a bottom cover mounted to the housing between the peripheral sidewall and beneath the housing top to enclose the heating element.
